(19) United States
(12) Patent Application Publication
(10) Pub. No.: US 2008/0293309 A1
(43) Pub. Date: Nov. 27, 2008

(54) Connector with improved contact for transmitting high current

(75) Inventors: Wei Yuan, ShenZhen (CN); Yu-San Hsiao, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/154,376

(22) Filed: May 22, 2008

(30) Foreign Application Priority Data
May 22, 2007 (CN) 200720037865.0

(51) Int. Cl. H01R 13/187; H01R 13/15

(52) U.S. Cl. 439/843; 439/839

(57) ABSTRACT

A connector includes a body (10), a plurality of passageways (104), and a plurality of terminals (30). Each terminal (30) has a mating portion (301), a mounting portion (303), and a connecting portion (30a) connected between the mating portion (301) and the mounting portion (303). All of parts of the connecting portion (30a), from a cross sectional view thereof, in area are the same and larger than that of any one of the mating portion (301) and the mounting portion (303), this configuration of which can carry high current as required.

### BACKGROUND OF THE INVENTION

1. Field of the Invention

The present invention relates to a power connector, and more particularly, to a power connector with contacts capable of transmitting high current.

2. Description of the Related Art

U.S. Pat. No. 6,364,718 issued to Polgar on Apr. 2, 2002 discloses a related connector including a contact having a mating portion adapted to mate with another connector, a mounting portion for being mounted onto a printed circuit board, and a connecting portion extending between the mating portion and a mounting portion. The mating portion, the mounting portion and the connecting portion, from a cross sectional view thereof, in area are the same, with all being of a square shape. The current connectors are required to transmit high current so as to cater for signal transmission. The contacts disclosed in the Polgar are incapable of transmitting the high current as required.

U.S. Pat. No. 5,366,381 issued to Kile on Nov. 22, 1994 discloses another related connector including some contacts with all of parts, from a cross sectional view thereof, being of a square shape, and another contacts in different locations having different shapes but their areas in cross sectional view being the same. These contacts are also incapable of transmitting the high current as required, because of all parts of each contact having the same areas in cross section view.

Therefore, there is a need to provide a connector with improved contacts to resolve the above-mentioned problem.

### SUMMARY OF THE INVENTION

A connector according to an embodiment of the present invention is provided to include a body, made of an insulative material, having a mating interface and a mounting interface thereof, a plurality of passageways extending through the body from the mating interface to the mounting interface, and a plurality of terminals received in the passageways respectively. Each terminal has a mating portion adjacent to the mating interface and shaped as only one finger extending into each passageway, a mounting portion adjacent the mounting interface and shaped as only one finger, and a connecting portion connected between the mating portion and the mounting portion. All of parts of the connecting portion, from a cross sectional view thereof, in area are the same and larger than that of any one of the mating portion and the mounting portion, this configuration of which can carry high current as required.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is an assembled, perspective view of an electrical connector according to an embodiment of the present invention;

FIG. 2 is another assembled, perspective view of the electrical connector of FIG. 1;

FIG. 3 is an exposed, perspective view of the electrical connector of FIG. 1;

FIG. 4 is another exposed, perspective view of the electrical connector of FIG. 1;

FIG. 5 is a perspective view of a contact of the electrical connector of FIG. 1 according to a first embodiment of the present invention;

FIG. 6 is a perspective view of a contact of the electrical connector of FIG. 1 according to a second embodiment of the present invention; and

FIG. 7 is a perspective view of a contact of the electrical connector of FIG. 1 according to a third embodiment of the present invention.

### DETAILED DESCRIPTION OF PREFERRED EMBODIMENT

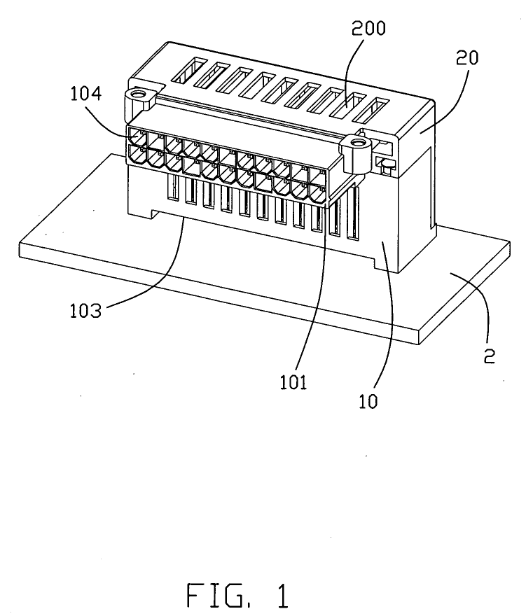

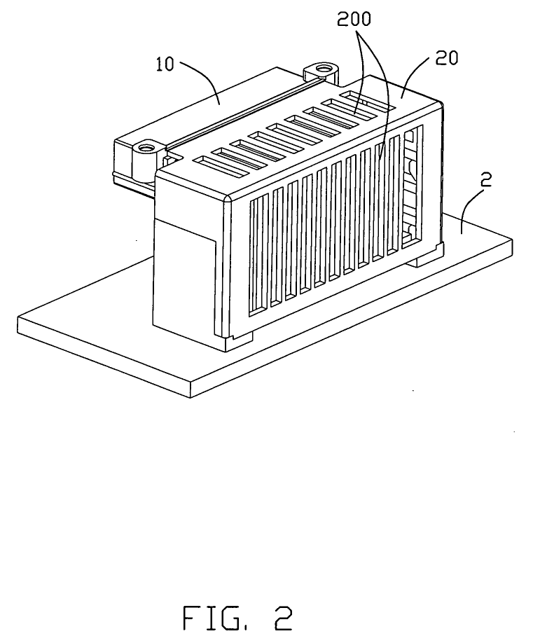

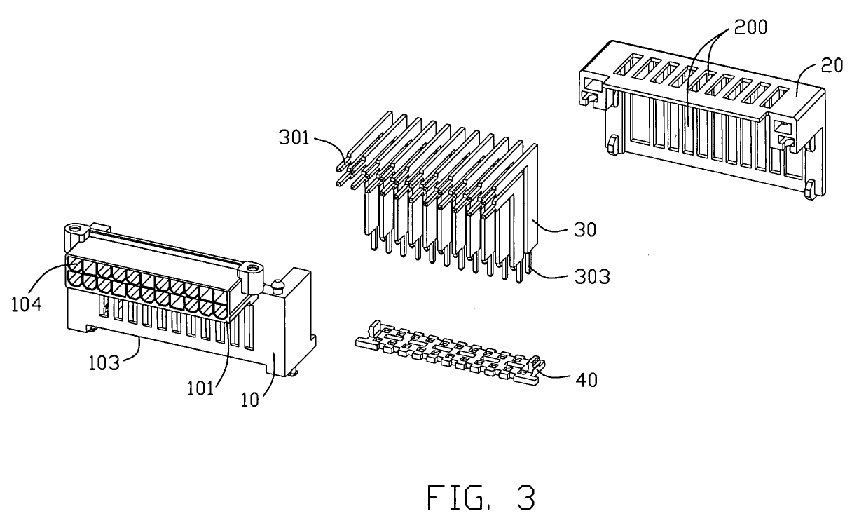

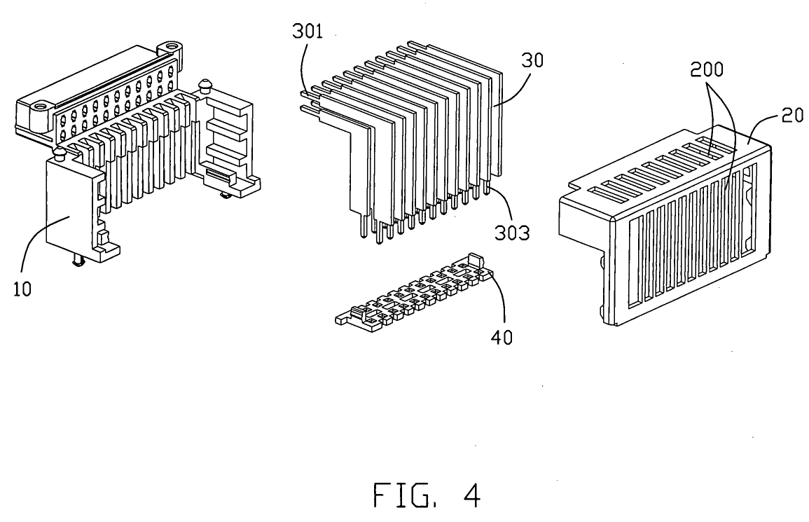

Referring to FIGS. 1 to 4, a connector according to an embodiment of the present invention is shown to include an insulative body 10 having an L-shaped configuration, a plurality of terminals 30 being of an L shape received with the insulative body 10, a cover 20 shaped as an L configuration to engage onto the body 10 for covering the terminals 30, and a spacer 40 disposed below a bottom area between the body 10 and the cover 20 for mounting portions 303 of the terminals 30 to be extended therethrough. The L-shaped body 10 of the connector is designed to have a mating interface 101, a mounting interface 103 disposed adjacent the printed circuit board 2, and a plurality of passageways 104 extending through the body 10 from the mating interface 101 to the mounting interface 103 for the terminals 30 to be received therein. The cover 20 defines a plurality of windows 200 for heat dissipation from the terminals 30.

Each terminal 30, being of an L shape, is designed to have a mating portion 301 adjacent to the mating interface 101 and shaped as only one finger extending into each passageway 104, the mounting portion 303 adjacent to the mounting interface 103 and shaped as only one finger, and a connecting portion or a base section, being of an L shape, connected between the mating portion 301 and the mounting portion 303. All of parts of the connecting portion, from a cross sectional view thereof, in area are the same, and larger than that of any one of the mating portion 301 and the mounting portion 303. In this embodiment, the mating portion 301 and the mounting portion 303, from a cross section view thereof, in area are also the same being of a square shape. In alternative embodiments, the areas of the mating portion 301 and the mounting portion 303, in cross section may be different with one being of a rectangle shape, the other of a circle shape depending on various applications.

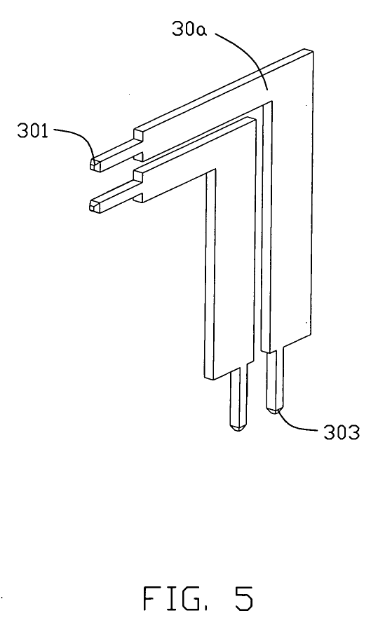

Referring to FIG. 5, the terminal 30 of the first embodiment includes the L-shaped connecting portion 30a having four faces including upper and bottom faces, left and right faces, and the mating portion 301 having four surfaces including upper and bottom surfaces, left and right surfaces. The connecting portion 30a, from a cross sectional view thereof, is of a rectangle shape. The upper and bottom faces of the connecting portion 30a are configured to extend beyond the corresponding surfaces of the mating portion 301, while the left and right faces of the connecting portion 30a is flush with the corresponding surface of the mating portion 301.

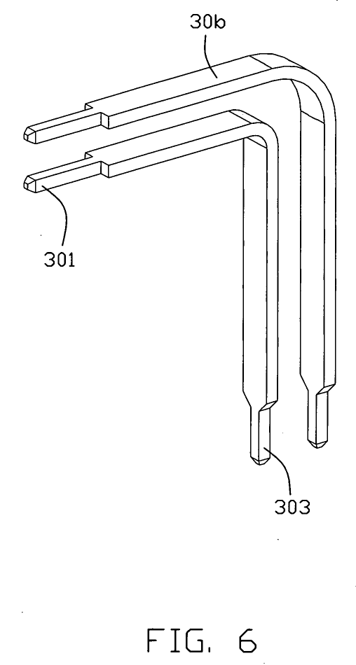

Referring to FIG. 6, the terminal 30 of the second embodiment includes the L-shaped connecting portion 30b having four faces including upper and bottom faces, left and right faces, and the mating portion 301 having four surfaces including upper and bottom surfaces, left and right surfaces. The connecting portion 30b, from a cross sectional view thereof, is of a rectangle shape. The left and right faces of the connecting portion 30b are configured to extend beyond the corresponding surfaces of the mating portion 301, while the upper and bottom faces of the connecting portion 30b are flush with the corresponding surfaces of the mating portion 301.

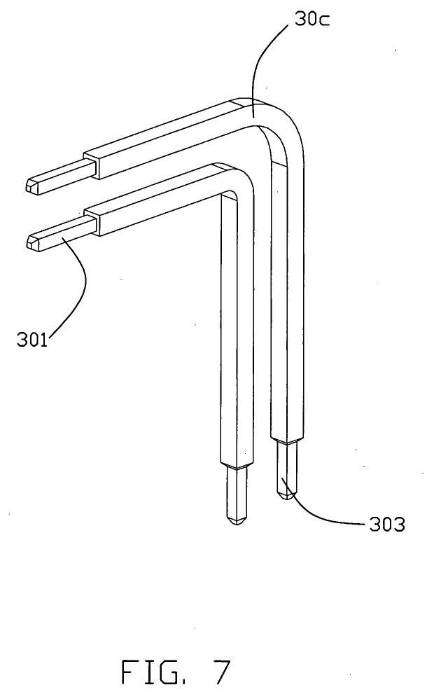

Referring to FIG. 7, the terminal 30 of the third embodiment includes the L-shaped connecting portion 30c having four faces including upper and bottom faces, left and right faces, and the mating portion 301 having four surfaces including upper and bottom surfaces, left and right surfaces. The connecting portion 30c, from a cross sectional view thereof, is of a square shape. The respective faces of the connecting portion 30c are configured to extend beyond the corresponding surfaces of the mating portion 301.

While the above embodiments of the terminal 30 is preferred, the connecting portion of the terminal 30 may be configured to have any shape, being of a circle shape or other shapes, from a cross sectional view thereof, having the same areas in all parts of the connecting portion but larger than that of any one of the mating portion and the mounting portion, this configuration of which can carry high current as required.

While the present invention has been described with reference to preferred embodiments, the description of the invention is illustrative and is not to be construed as limiting the invention. Various modifications to the present invention can be made to preferred embodiments by those skilled in the art without departing from the true spirit and scope of the invention as defined by the appended claims.

What is claimed is:

1. A connector comprising:
a body made of an insulative material, the body having a mating interface and a mounting interface, a plurality of passageways extending through the body from the mating interface to the mounting interface;
a plurality of terminals received in the passageways respectively, each terminal having a mating portion adjacent to the mating interface and shaped as only one finger extending into each passageway, a mounting portion adjacent the mounting interface and shaped as only one finger, and a connecting portion extending between the mating portion and the mounting portion, all of parts of said connecting portion, from a cross sectional view thereof, in area being the same and larger than that of any one of the mating portion and the mounting portion.

2. The connector of claim 1, wherein said connecting portion, from a cross sectional view thereof, is of a square shape.

3. The connector of claim 2, wherein the mating portion has four surfaces including upper and bottom surfaces, left and right surfaces, said connecting portion has four faces including upper and bottom faces, left and right faces, the respective faces of said connecting portion extending beyond the corresponding surfaces of the mating portion.

4. The connector of claim 1, wherein said connecting portion, from a cross sectional view thereof, is of a rectangle shape.

5. The connector of claim 4, wherein the mating portion has four surfaces including upper and bottom surfaces, left and right surface, said connecting portion has four faces including upper and bottom faces, left and right faces, the upper and bottom faces of said connecting portion extending beyond the corresponding surfaces of the mating portion, the left and right faces of said connecting portion being flush with the corresponding surfaces of the mating portion.

6. The connector of claim 4, wherein the mating portion has four surfaces including upper and bottom surfaces, left and right surface, said connecting portion has four faces including upper and bottom faces, left and right faces, the left and right faces of said connecting portion extending beyond the corresponding surfaces of the mating portion, the upper and bottom faces of said connecting portion being flush with the corresponding surfaces of the mating portion.

7. The connector of claim 1, wherein said connecting portion is of an L shape.

8. The connector of claim 7, further comprising a cover attached onto the body of the connector for covering the terminals, the cover defining a plurality of windows.

9. The connector of claim 1, wherein each of the mating portion and the mounting portion, from a cross sectional view thereof, is of a square shape.

10. A contact for a connector, comprising:
an L-shaped base section;
a mating section, being of only one finger shape, attached to the base section for mating with a plug connector;
a mounting section, being of only one finger shape, attached to the base section for being mounted to a printed circuit board; and wherein all of parts of said base section, from a cross sectional view thereof, in area being the same and larger than that of any one of the mating section and the mounting section.

11. The contact of claim 10, wherein said base section, from a cross sectional view thereof, is of a square shape.

12. The connector of claim 11, wherein the mating section has four surfaces including upper and bottom surfaces, left and right surfaces, said base section has four faces including upper and bottom faces, left and right faces, the respective faces of said base section extending beyond the corresponding surfaces of the mating section.

13. The contact of claim 10, wherein said base section, from a cross sectional view thereof, is of a rectangle shape.

14. The contact of claim 13, wherein the mating section has four surfaces including upper and bottom surfaces, left and right surface, said base section has four faces including upper and bottom faces, left and right faces, the upper and bottom faces of said base section extending beyond the corresponding surfaces of the mating section, the left and right faces of said base section being flush with the corresponding surfaces of the mating section.

15. The contact of claim 13, wherein the mating section has four surfaces including upper and bottom surfaces, left and right surface, said base section has four faces including upper and bottom faces, left and right faces, the left and right faces of said base section extending beyond the corresponding surfaces of the mating section, the upper and bottom faces of said base section being flush with the corresponding surfaces of the mating section.

16. An electrical connector comprising:
an insulative housing including a fowardly protruding mating port in a suspension manner and defining therein an array of cavities each essentially having a square cross-section for receiving a corresponding silo part of a complementary plug connector;
a plurality of contacts disposed in the housing each defining an L-shaped base portion with a mating portion positioned at a front end of the base portion and disposed in the corresponding cavity, and with a mounting portion positioned at a bottom end of the base portion and located around a mounting face of the housing; wherein
both said mating portion and said mounting portion have a similar size which is much smaller than that of the base portion at least in either a width direction of the contact or a thickness direction of the contact which are perpendicular to each other.

17. The electrical connector as claimed in claim 16, wherein said similar size is smaller than that of the base portion in both said width direction and said thickness direction 18. The electrical connector as claimed in claim 16, wherein the housing further includes an L-shaped cover defining thereof vertical and horizontal plates respectively supportably engaging the base portions of the contacts in both vertical and horizontal directions, and said cover is equipped with through slots in both said vertical and horizontal plates
